(19) United States
(12) Patent Application Publication
(10) Pub. No.: US 2018/0130050 A1
(43) Pub. Date: May 10, 2018

(54) EXTENDED BLOCKCHAINS FOR EVENT TRACKING AND MANAGEMENT

(71) Applicant: LedgerDomain, LLC, Las Vegas, NV (US)

(72) Inventors: Benjamin James Taylor, Las Vegas, NV (US); Gabriel Hare, Daly City, CA (US)

(21) Appl. No.: 15/454,492

(22) Filed: Mar. 9, 2017

Related U.S. Application Data
(63) Continuation of application No. 15/345,031, filed on Nov. 7, 2016.

(51) Int. Cl. G06Q 20/36; G06Q 20/38

(52) U.S. Cl. CPC G06Q 20/3674; G06Q 2220/00; G06Q 20/3829

(57) ABSTRACT

Blockchain-based systems and methods incorporate secure wallets; enhanced, randomized, secure identifiers for uniquely identifying discrete items; and cryptographically secure time-stamped blockchains. Role-based secure wallets include private cryptographic keys for digitally signing transactions for recording in a blockchain. Operations to be performed using role-based wallet can be permitted or restricted based on privileges associated with the respective wallets. Multiple blockchains can also be used to track transactions involving different units of account, for example, a measurement of a discrete product being transferred and an associated value of the transaction.

### CROSS-REFERENCE TO RELATED APPLICATION

This application is a continuation of and claims priority to U.S. patent application Ser. No. 15/345,031, filed on Nov. 7, 2016, and entitled “Extended Blockchains for Event Tracking and Management,” the entirety of which is incorporated by reference herein.

### TECHNICAL FIELD

The present disclosure relates generally to blockchain technology and, more particularly, to systems and methods for providing cryptographically secure supply chains for uniquely labeled or uniquely identifiable discrete products that can incorporate role-based digital wallets and multiple synchronized transactional blockchains.

### BACKGROUND

Blockchain technology has seen rapid development in digital currencies and specialty crypto-currencies due to its ability to rapidly validate transactions without mediation by a trusted third party. A key functional element of blockchain is linked time-stamping, which provides an inalterable archival record of transactions in temporal order. In addition, blockchain's cryptographic safeguards enjoy the feature of being highly transparent to stakeholders and policymakers while protecting individual user privacy.

Blockchains conform most closely to daybooks, journals, or blotters, as only the timestamp and amount in the relevant unit of account, for example number of bitcoins, is firmly established and the other data concerning the transaction is captured as a notation to the entry, like fleas on a dog. In summary, the strength of blockchain is its ability to reconcile and conserve the unit of account in near real-time, maintaining a single version of the events concerning the unit of account.

Newer blockchain systems often support advanced wallet functionality, some of which is embodied in the term “smart contracts.” This feature enhances the user's ability to code contingencies on the transaction, for example, a second signature, a waiting time, or a specified third party data point, such as the outcome of a sporting contest. In some implementations, users build these smart contracts into sub-wallets that are subordinated to main wallet. For example, in some implementations, the main wallet controls the account while a subordinated wallet, sometimes termed the Contract Wallet, controls the portion escrowed under the smart contract.

The Bitcoin implementation was also standardized to allow any participant to participate as many times as they wished under as many anonymized identities as they desired. Permissioned blockchains, in contrast, are not open to all participants and typically require some vetting, for example, certification by the system sponsor or their designate to gain the right to participate. Examples of system sponsors include exchanges, government and regulatory bodies, enterprises and cooperative organizations. Sponsors may choose to outsource certification, background checks, “know your customer” (KYC) checks and validation, but retain ultimate control over participation.

### BRIEF SUMMARY

The present application describes several novel and useful concepts, including blockchain-based systems and methods that incorporate secure wallets for participants in blockchain-based systems; enhanced, randomized, secure identifiers for uniquely identifying discrete items; and cryptographically secure time-stamped event records (blockchains). These system components working together form a secure envelope to provide assurance and enhance trust throughout a network. Aspects of the inventions disclosed herein include corresponding computer-implemented methods, systems, and computer-executable instructions stored on non-transitory computer-readable media.

Accordingly, in one aspect, transactional data is stored and conserved in cryptographically-signed blocks by receiving information associated with a transaction that includes first transaction data defined using a first unit of account and second transaction data defined using a second, different unit of account. A first block including at least the first transaction data is created, and is provided for addition to a first blockchain associated with the first unit of account. A second block including at least the second transaction data is created, and is provided for addition to a second blockchain associated with the second unit of account.

In one implementation, providing the first block for addition to the first blockchain includes using a private cryptographic key of a first user associated with the transaction to digitally sign (i) a hash of a previous transaction in the first blockchain and (ii) a public cryptographic key of a second user associated with the transaction. Providing the second block for addition to the second blockchain can include using the private cryptographic key to digitally sign (i) a hash of a previous transaction in the second blockchain and (ii) the public cryptographic key.

Various implementations of the present aspect can include one or more of the following features. A particular unit of account includes a measurement of a physical property of an object associated with the transaction, information associated with securing an object associated with the transaction as collateral, a reportable event, or a financial transaction metric. A particular unit of account includes a monetary value of the transaction or a unit associated with a loyalty program. The first and second blockchains include parallel transactional records of transfers of a product in a supply chain.

In some implementations, users able to generate a transaction for addition to a particular blockchain each have a respective digital wallet comprising a private cryptographic key for digitally signing the generated transaction. A particular digital wallet can include location information associated with an owner of the digital wallet, and creating a particular block can include including the location information with transaction information in the particular block. A particular digital wallet can be associated with a user role defining privileges associated with at least one of generating transactions and accessing existing transactions in a particular blockchain.

Certain implementations of the present aspect can also include one or more of the following features. One or more of the privileges are defined based on whether an owner of the particular digital wallet is within a geographical area defined by a geo-fence. A particular privilege includes an authentication requirement for a user associated with the particular digital wallet or a digital signature requirement for generating a transaction. A particular digital wallet includes a genesis wallet permissioned to generate an initial transaction in a blockchain. The initial transaction represents a newly manufactured item that can be, for example, time-stamped with a unique identifier and immutable product data (e.g., lot number, expiration date, etc.).

The users able to generate transactions can include parties associated with the manufacturing, distributing, dispensing, and/or consumption of a discrete product, and each transaction in a particular blockchain can define a transfer of the discrete product from one of the users to another one of the users. A particular user can include a consumer of a discrete product. The digital wallet associated with the consumer can include a reduced set of privileges compared to users associated with the manufacturing, distributing, and/or dispensing of the discrete product. The digital wallet associated with the consumer can be configured to receive information associated with consumption of the discrete product.

In another implementation, the transaction of a particular user is blocked based on an identification of problematic information associated with the transaction. The problematic information can include an expiration of the discrete product, a recall of the discrete product, and/or lack of rights of a transacting party with respect to the discrete product. Users upstream of the particular user can be notified of the blocked transaction. Based on at least one of the first blockchain and the second blockchain, users currently in possession of a particular discrete product can be identified and notified of a recall of the particular discrete product.

Other features of the present aspect can include any of the following. The first and second blockchains are locked to prevent further transactions from being recorded. The validity of the transaction is determined based on location information included in a previous block in the first blockchain and location information associated with a digital wallet being used to generate the transaction. The first and second blockchains are configured to prevent correlation of records in the first blockchain to records in the second blockchain.

In another aspect, transactional data is managed in cryptographically-signed blocks in a blockchain-based system. Digital wallets are identified, each including a private cryptographic key for digitally signing a transaction to be recorded in a blockchain, wherein a first one of the digital wallets is associated with at least one privilege defining a permitted or restricted operation of the first digital wallet within the blockchain-based system. A request is received for an operation to be performed using the first digital wallet, and the operation is permitted or restricted based on the at least one privilege associated with the first digital wallet.

The digital wallets can be respectively associated with parties associated with the manufacturing, distributing, dispensing, and/or consumption of a discrete product, and each transaction in the blockchain can define a transfer of the discrete product from one of the parties to another one of the parties. A particular transfer of the discrete product from a transferring party to a receiving party can result in the creation of a notarized block for validation of the discrete product by the receiving party. The notarized block can be verified without decrypting contents of the notarized block.

Various implementations of this aspect can include one or more of the following features. A digital wallet associated with a manufacturer includes a genesis wallet permissioned to generate an initial transaction in the blockchain, the generating including introducing a unique random identifier associated with the discrete product. The genesis wallet can introduce a unique random identifier A physical representation of the unique random identifier is disposed on at least one of the discrete product and packaging of the discrete product. The at least one privilege includes a security requirement for generating a transaction using the first digital wallet, the security requirement comprising at least one of multi-factor authentication, a cryptographic key, a challenge question, a digital signature, and a smart contract. Elements of the smart contract are at least one of transparent, encoded in a script, and remotely stored.

The at least one privilege can be defined based on (i) a size or type of transaction to be generated using the first digital wallet, (ii) a balance associated with the digital wallet, or (iii) an age of the digital wallet. The at least one privilege can also be defined based on whether an owner of the first digital wallet is within a geographical area defined by a geo-fence. The at least one privilege can permit or restrict resale of a discrete product, a short sale, a purchase or sale of a discrete product having a value that exceeds a threshold, purchase of a discrete product on credit, or generation of a transaction outside of a particular time period. The at least one privilege can be associated with a particular user role in a hierarchy of user roles, wherein each user role in the hierarchy defines a set of privileges to associate with a digital wallet to which the user role is assigned. The validation of external data points, such as geo-fencing, are difficult to enforce in a permissionless blockchain, but in the present system, the system sponsor can adjudicate as part of the quarantining and notarization process or on a post-trading basis.

The details of one or more implementations of the subject matter described in the present specification are set forth in the accompanying drawings and the description below. Other features, aspects, and advantages of the subject matter will become apparent from the description, the drawings, and the claims to persons of ordinary skill in the art and are considered to be within the scope of this disclosure.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the implementations. In the following description, various implementations are described with reference to the following drawings, in which:

FIG. 1 depicts a high-level architecture of a block-chain based system according to an implementation.

FIG. 2 depicts example transactions in a blockchain using role-based wallets.

FIG. 3 depicts an example method for notarizing a transaction according to an implementation.

FIG. 4 depicts an example method for validating a transaction according to an implementation.

FIG. 5 depicts an example implementation of a blockchain-based system in an exchange.

FIG. 6 depicts an example implementation of a blockchain-based system used for epidemiological sample tracking.

FIG. 7 depicts an example implementation of a blockchain-based system used for regulated product supply chain tracking.

### DETAILED DESCRIPTION

Various implementations are described for a blockchain-based system that provides cryptographically secure supply chains for discrete products and, further, which can incorporate role-based digital wallets and multiple synchronized transactional blockchains. In general, blockchains can include sequences of individual blocks that each memorialize transactions (individual events). A single block can account for a single transaction, such as a transfer of a single discrete product, or a group of transactions (e.g., sale of a million doses of a drug constituting a million transactions). In one implementation, a blockchain-based system employs sponsor-defined, sponsor-assigned, sponsor-managed privileges to tiers of users or individual users having associated digital wallets. The permissioning sponsor can assign a set of privileges (also referred to herein as permissions) appropriate to each user at the account level. The privileges can be packaged in bundles for participants to accomplish specific roles, so that different participants have differing permissions to transact and access data. These privileges are referred to herein as “role-based privileges” or “role-based wallets.” In specific implementations, only the sponsor or its designated administrator can add, modify, or delete privileges.

In another implementation, the blockchain-based system includes customized role-based wallets which can generate transactions accompanied by smart contracts. Each unit of account within this system is accorded its own blockchain with individual transactions being incorporated into several blockchains at once. One blockchain conserves and tracks one unit of account, such as measure (count, weight, volume, dose), with a different blockchain conserving and tracking another, such as the monetary value of the associated transaction. Other aspects of these transactions can be included within these blockchains, both to carry critical information about a transaction as well as extensions to further safeguard and authenticate the transaction. As used herein, transaction authentication can refer to the process of determining whether a particular user and associated wallet or application is permitted to participate in a transaction.

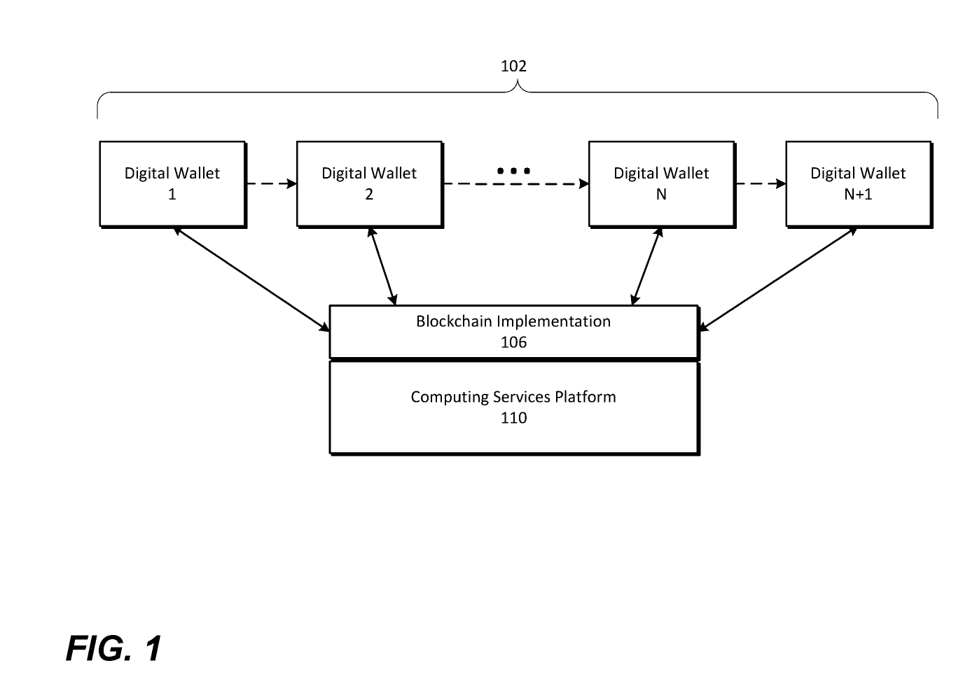

FIG. 1 depicts, as a high-level architectural overview, one implementation of a blockchain-based system that provides the features described herein. As shown, multiple digital wallets 102 associated with different users having different roles can be used to perform the operations and transactions described herein (e.g., digitally signing data using a key, transferring ownership of a product from a digital wallet associated with a manufacturer to a digital wallet associated with a distributor, and so on). Each digital wallet 102 can operate on a suitable user device, such as smartphone, tablet computer, desktop computer, laptop computer, smart watch, smart glasses, smart television, smart appliance, workstation, and/or other computing device. In some implementations, the digital wallets 102 take the form of mobile applications, such as iPhone or Android wallet apps.

To perform transactions, digital wallets 102 can interface with a blockchain implementation 106 that maintains the one or more blockchains or similar digital ledgers utilized in the present system. Blockchain implementation 106 can include, for example, Hyperledger Fabric made available by the Hyperledger Project. Blockchain implementation 106 executes on computing services platform 110, which can provide the necessary processing and storage functionality for blockchain implementation 106. Computing services platform 110 can be provided by a cloud computing services vendor and can include a platform such as Amazon Web Services, Microsoft Azure, and Google Cloud Compute. Cloud computing services platform 110 can also include a private cloud implementation in which only certain parties have access to the network. Other types of computing platforms are contemplated.

A suitable communications network can connect the devices on which the digital wallets 102 operate with blockchain implementation 106 and computing services platform 110. Communication can be achieved over media such as standard telephone lines, LAN or WAN links (e.g., T1, T3, 56 kb, X.25), broadband connections (ISDN, Frame Relay, ATM), and wireless links (802.11 (Wi-Fi), Bluetooth, GSM, CDMA, etc.), for example. In one implementation, the network carries TCP/IP protocol communications and HTTP/HTTPS requests made by a web browser, and the connections between devices and servers are communicated over such TCP/IP networks.

Referring in further detail to role-based wallets, privileges can be differentiated not only by the permissions granted, but also the frequency of access to use and transact on the system and the authentications required to access and transact. In this manner, stronger forms of authentication (beyond a baseline digital signature) can be employed selectively for larger transactions and for those participants carrying larger balances or with less experience. This blockchain and wallet system can be configured to strengthen authentication and achieve segregation of roles or duties through the further implementation of multi-factor authentication, challenge questions, multiple signatures, extra keys and/or special smart contracts to generate a transaction. Such additional forms of authentication are useful as protections to make humans aware of the transactions, thereby preventing usurpation via theft or other means.

This implementation can incorporate smart contracts and similar concepts which enable individual users to add pre-defined and/or custom contingencies to individual transactions, and can enhance the security and usability of the system for the benefit of all users. In this manner, participants in the permissioned blockchain are granted access that is consistent not only with their individual expertise, but the role that they are playing for a given account. Pre-defining these privileges and roles allows transactions to proceed quickly and seamlessly. This approach moves away from the traditional blockchain paradigm of the egalitarian one-size-fits-all model to one that balances the benefit and risk of each user's participation, which in turn maximizes the utility of the system and enhances trust.

Wallet privileges can be defined using one or more techniques. For example, the user's role can be governed by the client software (wallet) on the user device, or by a central database that manages specific user privilege. In another example, user identities can be grouped into tiers or roles. Some combination of these techniques can be used to enhance security and optimize system performance. These permissions at the user (client) level include tiered wallets and role-based wallets.

Permissions can also incorporate geo-fencing, in which certain permissions are extended to local participants, for example, those on an exchange floor defined by a geographic area. Similarly, capturing the geographic location of the user and geo-fencing of the privileges can also be used as part of an authentication or a licensing or regulatory check. In other examples, user location data can also be included in the blockchain so that fees and taxes can be properly allocated or assessed. In further implementations, geographic information can be used to determine which policy, rules, or regulations should apply to a transaction (e.g., if the transaction is occurring in one jurisdiction versus another), as well as to determine which regulatory entity may have authority with respect to a transaction (e.g., FDA in the US as opposed to a similar foreign authority if the transaction occurs outside the US).

In some implementations, roles, tiers or permissions are transparent to the entire network, whereas, in other instances, only the sponsor and the user will know their respective statuses.

Referring now in further detail to multiple-blockchain implementations, these implementations provide for multiple blockchains which form multiple archives conserving the integrity of different data fields from the superset of all transactions. Whereas, traditionally, blockchain technology has been focused on ensuring a financial component, such as bitcoin, is neither lost nor double-spent, the present system repurposes these safeguards to ensure the integrity of other transacted units including, but not limited to, number, weight, doses, count; custodied amount, area or volume; titled amount or area; deeded amount or area; or amount or area subject to bailment. The techniques implemented in this system allow for the record to be generated in a transparent and near real-time fashion.

This method can be extended to any number of units of account. An example of another unit of account is a unit associated with a loyalty program, such as frequent flier miles. Another example is an independent blockchain of security, in which secured loans are made as a component of the transaction, embedding the pledge, hypothecation or re-hypothecation of an asset for collateral within this new blockchain. Other units of account for separate blockchains include “reportable events” for regulators, such as anonymized medical lab results for the CDC, and transaction metrics for credit authorization and scoring.

The merits of this system are manifold. One key benefit is that each unit of account can be accounted for and conserved in near real-time: if for example, there are a million doses of serialized polio vaccine in the system, the blockchain of custody ensures that each dose is tracked and the total number of doses is conserved, regardless of the nature of the accompanying finances, even if some of the doses are given to a charity for no monetary compensation. The blockchains, which altogether encompass the raw data from every relevant transaction, can be stored together or separately and analyzed together or separately.

As such, parties who have an interest in the supply chain, such as regulators, can surveil a custodial blockchain, while financial details remain private. Sharing data amongst various regulators, even within the United States, is carefully managed through a combination of court orders and subpoenas; the present method simplifies this process and enhances the privacy of participants through its inherent segregation of data types, in effect, firewalling data fields from inception. In addition, near real-time analysis is possible, for instance, for the custodial blockchain, manufacturers and regulators can view a consolidated picture of all supply chain inventory in all warehouses and stores. This is particularly valuable and often mandated in sensitive supply chains where lives are in the balance due to shortages and product recalls.

In certain systems, these segregated blockchains can be linked by the common timestamps of the transactions, so that all the data would be available if all the blockchains were available to the viewer. In other instances, the blockchains can be segregated from one another, enhancing privacy and anonymity. One such technique is to introduce noise into transaction timestamps in one of the blockchains, to foil attempts to merge the data back together.

In some implementations, the blockchain-based system is adapted to provide a chain of custody system with customized role-based wallets which can generate transactions accompanied by smart contracts for the management of product supply chains. The primary unit within this system is unit of measure (e.g., count, weight, volume, dose) for the discrete product, with the monetary value being a subordinated unit, if present at all. Transactions captured by the blockchain(s) can include spatial and temporal extensions to further safeguard and authenticate product movement.

Relevant supply chains include regulated products such as foods, drugs, medical devices, diet supplements, tobacco products, cosmetics, veterinary products, firearms, alcohol and explosives. Examples of raw materials that may benefit from this system include radioactive isotopes and genetically-modified seeds. These supply chains are regulated in many jurisdictions, but typically through a patchwork of national and state regulation. These supply chains are increasingly difficult to regulate due to globalization of both raw materials and finished products. Supply chain transparency for regulated products is serves the interest of public safety and the public's right to know and is mandated in many jurisdictions. This system can also be useful for highly sensitive supply chains such as those supporting military logistics, cryogenics or space travel. The system can also be configured with a reverse flow, for example, for the collection and management of medical lab samples, but in that configuration, the sample would move from the end-consumer to the laboratories. Further still, the present system can be configured to uniquely identify and track consumer products or other types of products offered by a company in order to deter counterfeiting (e.g., to track genuine Louis Vuitton purses or Nike sneakers).

Contemplated uses include tracking raw materials from industry vendors, through manufacturing at the lot level, to packaging at the package level, through the distribution chain to the end consumer. The present system provides a near real-time chain of custody and a permanent, inalterable archive of movements of regulated products through to the end user with the potential of facilitating product movement and reducing inventory.

The usage of this system will reduce the use of counterfeit, stolen, contaminated, expired, or otherwise harmful products. The system will improve detection and removal of potentially dangerous products from the supply chain to protect consumers. In addition, the embedded historical record provides a trail for billing and enables a full audit. This audit can enhance fairness and further analysis of public policy and can identify users who are accessing product in quantities that might signal misuse, abuse or a threat to public safety.

This system can be sponsored by the regulator or sponsored and managed by the regulated entity or a group of similarly situated entities to satisfy regulatory or compliance objectives. The sponsor can remotely lock-down the system to prevent new transactions or further product flow and support re-deployment during emergency situations.

The blockchain-based systems described herein can use standard elements, such as virtual wallets for each system user and peer to peer interactions, and can include some combination of role-based wallets, specialized validation techniques and tiered permissions to access data. The validation process can use a third-party computation to create blocks, and geographic coordinates associated with digital wallets and/or discrete products can be driven by multilateration techniques supported by GPS, GLONASS, Wi-Fi position, or active or passive elements attached to user devices and/or products themselves. In some instances, such location techniques can also be used to ensure that a transaction makes sense (e.g., by determining if a current geographic location of a digital wallet matches a location in a previous transaction or some other expected location). This can be particularly important at the point of entry into the system. For example, each genesis wallet relating to the manufacturing of a drug product can be certified at the package/Universal Product Code (UPC) level and plant (Data Universal Numbering System (DUNS) number), so that if the wallet is certified for a single pack of the drug made in one country, any product made outside that specific geography would be unable to be added to the blockchain. The validation of external data points, such as geo-fencing, are difficult to enforce in a permissionless blockchain, but in implementations of the blockchain-based systems described herein, the system sponsor can adjudicate as part of the genesis process.

Generally, as described herein, validation refers to the process of determining whether one or more aspects of a transaction are in good order (e.g., determining that the seller of a product actually owns or otherwise has valid rights to transfer the product to another). Third-party validation can be performed by competing validators, such as the Satoshi method employed by Bitcoin; by trusted validators; by peer-to-peer protocols; or by the public agency sponsor and their designated contractor(s). The smart contract elements can be transparent (such as in the case of, e.g., expiration dates), encoded in scripts (e.g., python scripts for physician scrip data) or stored remotely in a companion program. The geometric information can be embedded directly into the blockchain (e.g., included in the notarized description of a transaction), or it can logically map onto a separate database or lookup table. This lookup table can be configured so that consumer data is organized at the zip code level while distribution data is kept at the warehouse number or nine digit zip+4 code, to further privacy interests. This designation can discriminate amongst private warehouses, bonded warehouses and special enterprise zones, to facilitate tax and regulatory compliance. System sponsors can host multiple blockchains instantiations to segregate viewing, lower complexity and enhance system performance.

The blockchain and wallets can be configured to accept fractional packages, for those packages that may be subdivided at the retail level prior to distribution to the end consumer and those that are commonly subdivided, such as pharmaceutical injectables at hospitals and clinics. The blockchain and wallets can be configured to require multiple signatures, extra keys or a special smart contract to generate a transaction, for example a physician scrip in addition to the dispenser key prior to release to the end consumer.

In one implementation, the present system includes tiered user roles. An authentication/authorization server can grant privileges and configure wallets with certain permissions and requirements. For example, manufacturers who are adding newly qualified inventory to the system can have genesis wallets for the creation of newly manufactured product, while distributors can have role-based wallets allowing them to move larger amounts of inventory and view its shipment patterns, and, likewise, end-users can have wallets allowing acceptance of smaller amounts and incorporating limited data access. These special wallets can be configured by the authentication/authorization server to require multifactor authentication, challenge questions, multiple signatures, extra keys or a special smart contract to generate a transaction. The wallets can include data acquisition components, such as OCR readers and barcode and QR code scanners, to facilitate the transaction and enhance accuracy. Another wallet flavor is the sentry wallet, which is only allowed to confirm the location of inventory and not transact; this can be used by security personnel and/or those performing a physical inventory. This wallet adds a null transaction to the blockchain noting a time-stamp and, optionally, a physical location. The genesis wallet can be maintained without a network connection or peering-to-peers to enhance its protection from malicious acts.

Other privileges associated with digital wallets can include limitations on frequency of access to use and transact on the system, requirements for authentications to access and transact on the system (e.g., require stronger forms of authentication for larger transactions and for those participants carrying larger balances or with less experience), ability to maintain a negative (short) balance, ability to enter into larger purchases and sales, ability to purchase on credit, and ability to transact outside market hours. In some implementations, location information (from GPS or other location techniques) is used in conjunction with a geo-fence to determine whether a transaction is permitted. In general, such information external to the blockchain (e.g., location, time, wallet balance, wallet age, etc.) is fundamentally qualitative. Accordingly, it should be noted that, so long as this information is used to defer transactions and does not cause a modification of the blockchain, possible states cannot be contradictory, where “possible” includes states that can only be reached by falsifying outside information.

End user/consumer wallets can be restricted from reselling items tracked by the blockchain (critical for drugs, tobacco and luxury product gray markets), and can be the only wallet permitted to receive delivery of warranty and user instructions. The system can be used to request partial or full payment by an insurer or payer and an advance for or a discount on co-payments. The system can further be used to automatically generate a warranty card for e-signing and e-delivery back to the manufacturer and can retain the warranty card within the consumer's wallet. Sellers (e.g., drug companies) can also receive e-confirmation of delivery of package inserts and med guides as well as provide reminders of compliance.

There can be discrimination amongst the consumers and, in the case of controlled products, prescribers, with privileges for military and first responders. Tor protocols and continuous updating of wallet identities can be implemented in certain jurisdictions to enhance security and accomplish local privacy objectives.

Privileges and restrictions associated with a digital wallet can interact with statements of contingencies and requirements for transactions contained in blocks in the blockchain. For example, a block validating ownership of a dose of an opioid might also contain the stipulation that the sale of an opioid requires the participation of the current owner, the patient, and the Drug Enforcement Agency (DEA). It can be further stipulated that the patient must demonstrate that they have a prescription via another block in the chain. Similarly, the patient's prescription block can stipulate that the provider of the dose must demonstrate ownership and can also require that the DEA be able to view the block describing the transaction.

In general, contingencies can require anything that can be satisfied via a disclosure of another block in the block chain. For example, a prescription produces a block in the chain. The patient is required to present proof of identity, and may have to disclose their medical records to demonstrate that the prescribed drug would have no adverse reaction when taken in conjunction with any other prescribed drug. Likewise, a block for a controlled substance may require that at the final sale the recipient provide a block demonstrating a prescription.

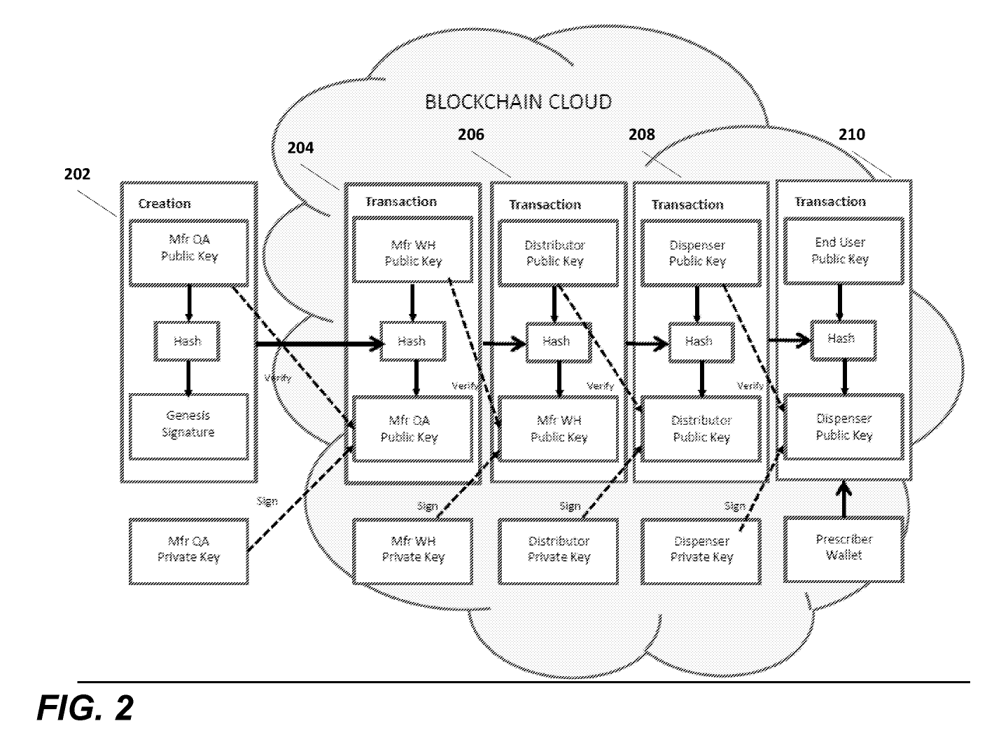

FIG. 2 depicts an example transfer flow of a discrete product (e.g., a regulated product, such as a food product, drug, cosmetic, tobacco product, vaccine, medical device, firearm, or other discrete product) starting with its creation by a manufacturer to ultimate receipt by an end user. Each transaction (transfer of the product from one user to the next) is recorded in one or more blockchains To describe the process illustrated by FIG.2, the example of a prescription drug supply chain will be used; however, it should be appreciated that a wide variety of supply chain configurations for different products can be used with the presently described techniques.

Here, creation 202 of a new drug product (e.g., manufacturing of a pill) is an action that only licensed manufacturers can engage in. To create a block identifying a valid pill, a manufacturer uses its digital wallet to provide a description of the transaction (pill identity assignment) and a genesis signature for the transaction. The pill identity assignment can include a unique identifier that is sampled randomly (without replacement) from a moving range. This random sampling technique, as opposed to sequential identifiers or batch ranges, makes it far less likely that distribution information could be reconstructed by a third party. The unique identifier can appear on the product and/or its packaging as, for example, a standard barcode, 2D barcode, quick response (QR) code, bokode, or similar identifier. The unique identifier can also be communicated through radio or other signals, such as by using an RFID tag and reader. Regardless of the form of unique identifier, the manufacturer can then digitally sign the pill identity assignment. To avoid the introduction of falsified items, this signing can be performed using, for example, unique private keys generated for each item or for regular time intervals (e.g., for each day).

In some implementations, one or more notary computing systems, or “notaries,” (further described below) verifies the signing manufacturer's identity and its permission to manufacture the described item. To achieve this, the manufacturer can provide a reference to a block in which their license is granted and the decrypted contents of that block. The notary (or notaries) has access to the public key information for the manufacturer (Mfr QA Public Key) and for the referenced cryptographic block. The public key can be applied to the genesis signature to verify that the manufacturer is who they claim to be. Likewise, the referenced block can be verified to have been notarized, and the associated public key can be applied to the provided unencrypted data to verify that the manufacturer is in fact able to decrypt the block contents. An entry evidencing the creation of the drug product can accordingly be added to one or more blockchains (e.g., a blockchain tracking the measurement of the product, a blockchain tracking a monetary value associated with the product, etc.).

In transaction 204, the custody of the drug product is transferred from the manufacturer to a warehouse using their respective digital wallets, resulting in an event in the blockchain. In this transaction 204, the private cryptographic key of the manufacturer (Mfr QA Private Key) is used to digitally sign a hash of the previous transaction in the respective blockchain (i.e., creation 202) and the public cryptographic key of the warehouse (Mfr WH Public Key), and this information is stored as part of a new block added to the one or more blockchains. As shown, the manufacturer's public cryptographic key can further be used to determine the validity of the transaction.

In one implementation, transferring the product incorporates validation by one or more notary parties. In this implementation, in transaction 204, the current owner (here, the manufacturer) designates the intended receiving party (or parties, e.g., when a distributor intermediary is used) and cryptographically signs the declaration of this intent. To avoid unauthorized reconstruction of events, the signing can be performed using unique private keys generated for each product item. Each notary verifies that the transferred item is valid and reviews any permissions associated with the transferred item. If a request to transfer the item is denied, it may indicate the arrival of new information in the blockchain (or an error in or attempted circumvention of the system). The current owner of the item can be notified of the denial. If, however, permissions permit the transfer, the notary can participate in finding a valid representation to add to the blockchain. Of note, the right of validation is a part of the transfer. Consequently, the result of a transfer is that the receiving party acquires a right of validation for the received items. In general, the transferring party loses the right of validation, but may still be able to assess validity of an item due to other granted rights.

Still referring to FIG. 2, and continuing in the same manner, the product can be transferred from the warehouse to a distributor. That is, in transaction 206, the private cryptographic key of the warehouse (Mfr WH Private Key) is used to digitally sign a hash of the previous transaction in the respective blockchain (i.e., transaction 204) and the public cryptographic key of the distributor (Distributor Public Key). Again, this information is stored as part of a new block added to the respective blockchains. The process continues in the same manner, in transactions 208 and 210, to transfer the product from distributor to dispenser, and dispenser to end user.

Notarization, as generally used herein, refers to the process of entering validated transactions from authenticated users into a blockchain. Notarization can occur when one or more parties requests a particular transaction, and completes when a block describing the transaction is added to the blockchain ledger. Notary systems have two responsibilities: to verify that all requirements for a transaction are satisfied, and to perform the work necessary to notarize the addition of the transaction to the block chain.

Notaries can be implemented on secured servers. These servers can send notarization results to parties that are encrypted using public keys of the authorized parties. Any party can receive results of a query, but only the authorized party can decrypt them. To avoid a single point of failure, multiple independent secured servers can be used. These servers can all participate in the process of notarization, so that even if one server were exploited to validate non-compliant transactions, all other servers would be able to identify the conflict. Since various agencies require insight into aspects of the distribution and consumption mediated by the block chain, those agencies should retain replicas of the relevant portions of the database, and should participate in notarization of transactions within their purview.

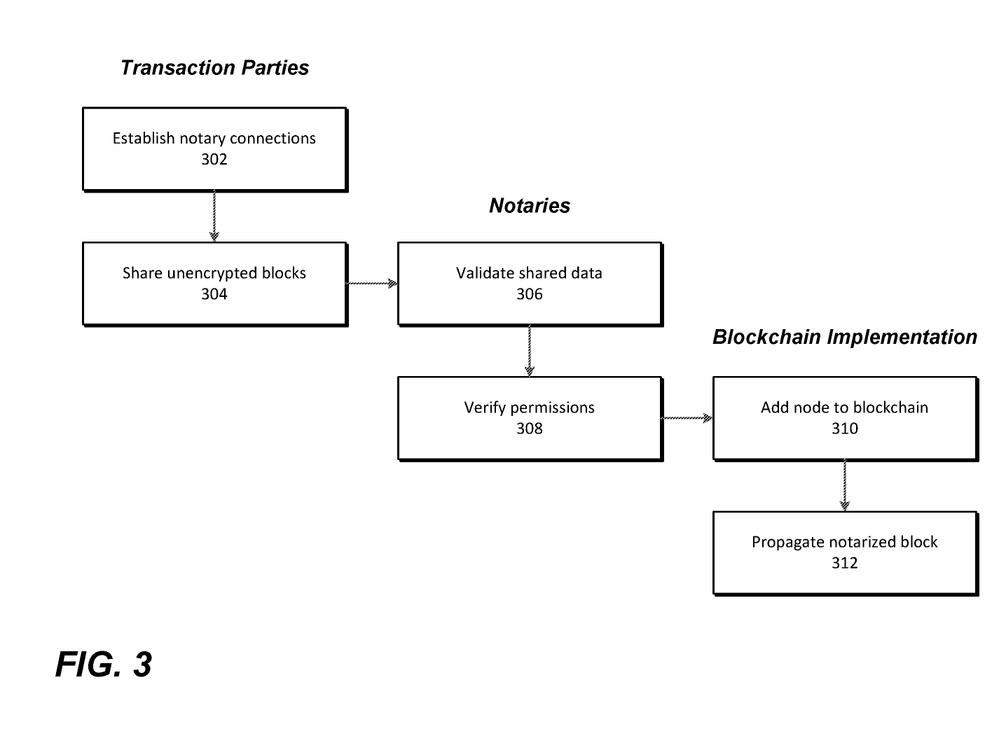

FIG. 3 depicts an example method for performing notarization of blockchain transactions. In Step 302, the parties involved in the transaction (e.g., item transferring party and item receiving party) establish secure network connections with the same set of one or more notary computing systems, or notaries. Each party securely shares with the notary set the data in blocks, in unencrypted form, needed to validate the transaction (Step 304). As some examples, a pharmacist can share item data verifying that the pharmacy possesses and has the right to sell an item, and a patient can share the prescription for the item. The information can be shared by providing a reference to a block in the blockchain that contains the information. In some implementations, if any additional party is required to be able to view the transaction, that party must also provide proof of presence.

In Step 306, each notary validates the shared data by first verifying the notarizing hash on the referenced block (the hash created when the referenced block was added to the blockchain), and, then, by encrypting the data using the public key associated with that block. Each notary assesses the rights demonstrated by each party in the transaction and verifies that the rights grant permission to perform the requested transaction (Step 308). These rights can be defined by the privileges associated with each user's role-based wallet. Some actions (e.g., controlled medication prescription) might mandate evidence of completeness of disclosure. Other actions (e.g., item genesis) might require verification of a cryptographic signature identifying a party.

The data describing the transaction is encrypted using a public key shared by the parties in the transaction. In some implementations, the data describing the transaction includes references to blocks used to validate the transaction, description of an item that is the subject of the transaction (e.g., medication type, dose, expiration, etc.), an identification of the previous owner and/or new owner (using, e.g., public keys of those parties), a declaration of permitted actions of the new owner, and/or any requirements for the transaction to proceed. As one example of transaction data, if a drug company expects to be able to audit all transactions associated with their pills, then the data in each block can stipulate that the company must be able to decrypt the subsequent custody block, and that the subsequent block must include the same stipulation.

The encrypted data and the public key together constitute a block. The transaction is complete when the block chain, with the addition of the new block, has been cryptographically notarized (Step 310). The addition of a notarized block can then be propagated to all relevant notaries (Step 312). Advantageously, the notarization can be verified and other notaries can validate transactions without requiring that the contents of the notarized block be decrypted. An important consequence of this approach is that the data stored in the block chain is fully encrypted. If a server participating in notarization were compromised, the only private data that would be exposed would be the data provided to validate new transactions.

More generally, in the case where multiple parties need to be able to read the block, a key can be generated and shared by those parties. Alternatively, a copy of the block data can be encrypted using public keys provided by each party. The block would then consist of multiple copies of the data encrypted using a public key, as well as the public keys used for the encryption. By re-encrypting using any public key, any party could then verify that the other parties see the same information when they decrypt their copy of the data from the block.

Public data can also be included in a particular block. For example, it might be desirable for a notary to be able to verify that a block establishing ownership of an item has not been used more than once to validate a change of ownership. In this case, the notary would need to be able to determine that an existing transaction block has referenced the ownership block, despite being unable to decrypt the existing transaction block. An alternative to public custody referencing is to have entire chains of custody be included in the encrypted data, which is subject to frequent auditing by an authorized party.

One method of referencing a block to validate a transaction is to provide the block index and the unencrypted block contents. The notary then verifies that the known public key yields the same encryption as is in the block specified by the index, and further verifies the hash on that block. However, this process does not require that the “encryption” process be lossless—it could just be a hashing function with the property that strings yielding the hashed result are difficult to determine.

In one implementation, validation (or invalidation) of an item involves at least four query types: (i) expiration: querying data included in the item description; (ii) quarantine or recall: querying item status defined outside of the chain of custody; (iii) conflict: verifying that there is no conflicting chain of custody of the item; and (iv) pedigree: following the chain of custody back to a valid genesis block.

In some implementations, validation can be performed by (and, in some instances, only by) authorized agents. These agents can include, for example, a regulatory agency (e.g., Food and Drug Administration (FDA), DEA, etc.), a licensor, a current owner of an item, and an agent authorized by an item owner. In some cases (e.g., urgent treatment medications: epi-pen, naloxone, etc.), attributes of an item (e.g., location, validity) can be publicly viewable to facilitate rapid response by any party. In the case of product transfer, when final sale for consumption occurs, no further transfers are possible, meaning that only the consumer and authorized agents can assess the validity of an item. Consequently, a prescribed item purchased from the intended consumer would not be able to be validated.

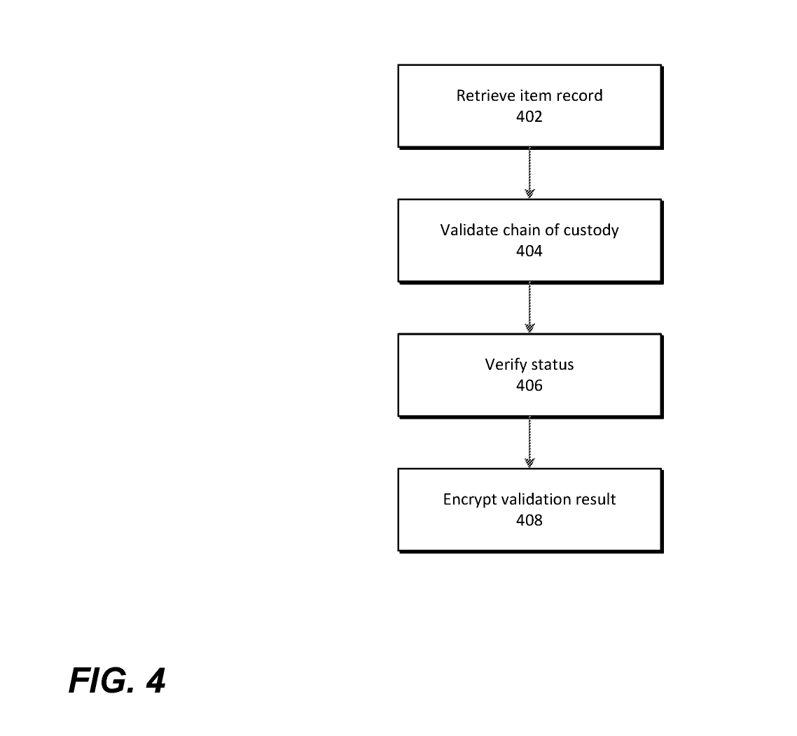

Referring now to FIG. 4, validation of a block in a blockchain tracking an item includes verifying the chain of custody of an item, which can be accomplished in one implementation as follows. In Step 402, a record associated with the item is retrieved using a unique identifier (e.g., bar code, serial number) associated with the item. The chain of custody of the item is validated up to the requested block in the blockchain (Step 404), and an evaluation is made to determine if there is any conflicting history, whether the item has expired, and whether any quarantine or recall has been issued for the item (Step 406).

Various techniques can be used to achieve the foregoing steps. For example, a user's wallet can include a table associating item serial numbers to indices of blocks that demonstrate ownership of the item. The user then contacts any notary to request the indexed block, and on receiving the encrypted block (and any additional blocks used for the hashing), verifies the hash and decrypts the contents of their block using their private key. These steps are sufficient to verify the item status at the time it was obtained.

In the case of a quarantine or recall, a block declaring the quarantine or recall can be issued that references some custody blocks (for example, all pills from a mishandled shipment). A query regarding any custody block derived from those blocks can be informed of the quarantine or recall. In the case where custody references are public, the notary can reconstruct this chain. On the other hand, in the case where the references are private, the indices of the entire chain can be in the encrypted data, and the referencing of each node by any quarantines or recalls can be queried by the user.

Still referring to FIG. 4, as part of notarizing the transaction, the results of the validation can then be encrypted using the public keys declared for the item and block (Step 408), and the encrypted result returned (Step 410).

In some implementations, as part of effecting the validation of a block, a party involved in a transaction should know the blockchain index associated with the transaction. For example, such parties can be responsible for maintaining a database mapping product identifiers with blocks. In order to reconstruct the history of an item, a user should then have the ability to decrypt each referenced prior transaction block (which is generally a subset of the total referenced blocks). Further, in order to validate an item, the user need only have permission to view any single blockchain block in the item's history.

Advantageously, in addition to the blockchain capturing each transaction, the total number of units are conserved by blocking any transactions that double-count. This failsafe can be applied to additional units of account (e.g., number of units) in additional blockchains, such that no double counting occurs, nor are dollars or additional units lost. Each blockchain decrements and increments an equal amount for every block, and each blockchain conserves the total numbers of units of that unit of account. In some implementations, the accuracy of the number of units and the accounting of other tracked values within blockchains relies on auditing of the transactions by an authorized party.

Consider now, for example, the specific case of pills in blister packs, where each blister pack has an unique QR code identifier on the foil. There are three cases of illicit action that would modify the number of valid pills in the system: (1) add pills that are assigned new identities, enabling someone to sell illicitly manufactured pills; (2) replicate valid identifiers, but use them for illicitly manufactured pills; and (3) remove pills associated with valid identities, enabling the unregulated selling of valid pills. Each case can be addressed differently, as described in the following example illustrations.

Case 1: Creation of a new pill is an action that only licensed manufacturers can engage in. To create a block identifying a valid pill, a manufacturer provides at least three things: a description of the transaction (pill identity assignment); an cryptographic signature for the transaction; and a reference to a block in which their license is granted and the decrypted contents of that block. Here, a notary has access to the public key information for the manufacturer, and for the referenced cryptographic block. The public key can be applied to the cryptographic signature to verify that the manufacturer is who they claim to be. Likewise, the referenced block can be verified to have been notarized, and the associated public key can be applied to the provided unencrypted data to verify that the manufacturer is in fact able to decrypt the block contents.

Case 2: A transaction (e.g., the sale of an item) requires demonstrating ownership of the item, the right to sell the item, and the right of the recipient to gain ownership of the item (e.g., that they have a prescription). Given another pill using the same identifier, the problem is to provide proof that a second transaction by the initial owner is permitted, when that proof was already used for a previous transaction. After a transaction, a block demonstrating ownership is marked as no longer pertinent. Thus, even if a second transaction were notarized, the conflict would be identified, enabling a quarantine to be issued for that pill.

Case 3: Any transaction involving a pill (e.g., sale) involves the creation of a new notarized block that is viewable by the recipient. This block is used by the recipient to validate the pill. While there is nothing to stop the physical sale of a pill, the value associated with a pill that cannot be validated is expected to be impaired. If, in addition to the sale of the pill, access was given to a block that could validate the pill, the seller would have to provide the private key to that block—which would amount to selling their access to all such blocks. For example, if someone with an opioid prescription were to sell a single dose of an opioid, in order for the recipient to validate it they would have to expose their entire prescription.

Additional safeguards include the involvement of a regulating party, such as the drug manufacturer, drug developer, the FDA, or the DEA, who are able to view the resulting block in which the pill identity is created. This party would be required to be involved in every transaction within their purview so that they could decrypt those blocks, or could render invalid any block that they cannot decrypt. And, in the case where conflicts are encountered in the transaction history of an item, they would be able to decrypt all transaction blocks in order to resolve the conflict.

In one implementation, the presently disclosed techniques allow for the automatic blocking of transactions relating to a product tracked by the blockchain-based system. Such blocking can occur in the event that, for example, the product has expired or has been recalled. Transaction blocking can also occur upon an attempt to transact with an item that is no longer owned, or on an attempt to transfer an item to a party that cannot demonstrate a right to possess the item (e.g., for controlled substances). Upstream participants can also be automatically notified upon the blocking of transactions based on any such problematic information. The following blocking technique uses the example of a product recall based on a determination that a lot of medication received from a manufacturer is toxic. In this implementation, a publicly viewable block is added to the blockchain, issuing a recall and listing the identifying numbers of the recalled items. Individual users who try to validate or initiate a transaction for a recalled item are accordingly informed of the recall. For such a user attempting a validation, the user's system searches for any pertinent recalls or other issues in the blockchain. Likewise, in attempting a transaction, a notary searches for and identifies the same. Ultimately, the result of the recall block in the blockchain is that further transactions regarding the recalled product can be blocked, and upstream users notified of the recall. As an example, a care provider (e.g., prescriber or dispenser) who has been granted access to a user's account will know the identifying numbers of the medications possessed by that user. When a recall is issued, the care provider can directly inform (via text, phone, etc.) that a recall has been issued on an item.

In another implementation, the present system allows for licensing and prescription using role-based wallets. For example, a regulatory agency (e.g., the FDA or DEA) can authorize a company to license the manufacturing of an item to one or more parties. Such licensing can be constrained by quantity, time, or other conditions, and licenses can be suspended or revoked. In some instances, licensing is required for all non-consumer roles (e.g., distributor, prescriber, etc.).

A prescription is similar to a license, in that it creates a permission associated with a system user. In this case, it creates the right of the user to receive an item of a specific type (e.g., medication and dosage) in specified instance quantities, with a specified time interval between instances, and possibly a maximum number of instances or maximum quantity. Smart contracts can also be used in connection with prescription transactions in a blockchain, with such contracts including conditions and/or terms based on the existence of, e.g., prescriber keys, prescriptions, and refill authorizations. As one example, when a prescriber having access to a patient's medical records wishes to modify the patient's prescriptions, the following actions are taken: (i) the prescriber requests the patient's records (which includes prescriber identities); (ii) the prescriber's status is verified, which can include a check of the blockchain for any downstream blocks revoking a license; (iii) the prescriber receives the patient's information encrypted using the public keys of enabled parties; (iv) the prescriber defines the modification (e.g., adding a prescription) and provides the medication information as part of a block demonstrating the prescriber's ownership (the information can include any pertinent stipulations, such as escalation or antibiotic treatment); (v) the prescription is checked against known restrictions (e.g., allowed total dose of narcotic, allowed escalation of antibiotic treatment) and the medication is validated (e.g., ensuring there is no downstream change of ownership, nor any quarantine or recall); and (vi) the prescription is added to the patient's digital wallet (no counter-sign by the patient is required). Only the index of the notarized block need be shared to perform the addition to the wallet. In one implementation, two-factor authentication is used for certain controlled substances, such as opiates.

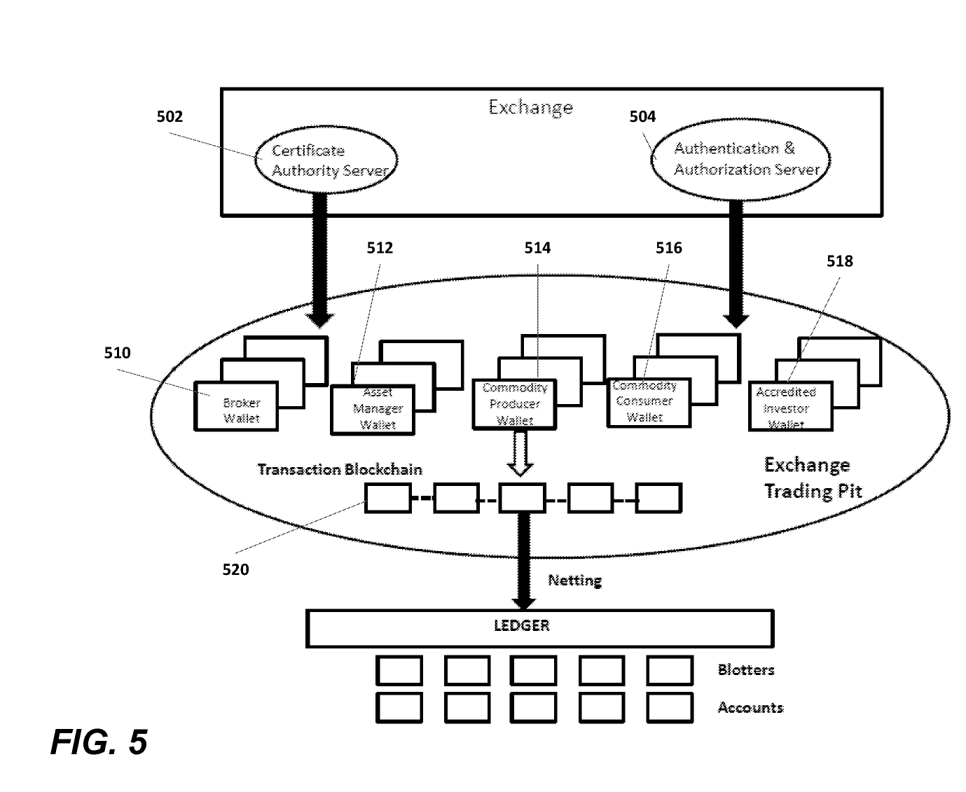

Various applications of the techniques disclosed herein will now be described. Not every chain of custody conforms to a linear path to the end user; many have active internal markets. Systems configured for active internal markets make use of the role-based wallets disclosed herein but can choose to have a netting system employed prior to notarization at the end of the session. In one example of a blockchain-based system using role-based wallets, as depicted in FIG. 5, the system is configured for a commodity exchange, in which a variety of enterprises including brokers, institutional asset managers, commodity producers and commodity consumers all participate. Some enterprises can have a single user, but many have many registered users, each of whom is individually vetted and issued certificates by certificate authority server 502. Each user is issued a client wallet which must be re-authenticated and re-set prior to the beginning of each trading session by connecting with the authentication server 504. These wallets, named after their associated parties, include broker wallet 510, asset manager wallet 512, commodity producer wallet 514, commodity consumer wallet 516, and accredited investor wallet 518. Each wallet has settings which limit order quantity and total position limits; orders exceeding limits require a second signature. This is implemented in part to reduce the likelihood of a “fat finger” order or to foil an attempt to crash the system.

Pre-defined “smart contracts” are utilized to trade derivative contracts, such as simple options, baskets and futures. Higher complexity arrangements are made off-exchange and then entered into the blockchain as an addendum to the trading session post-close.

Exchange rules limit short positions by asset managers and commodity users, and obligate those participants to disclose their intent to the exchange, either directly on the blockchain or through a separate filing. Their wallets have limits to eliminate inadvertent short positions or overdrafts. Retail participants who are accredited investors can obtain wallets allowing direct access to the exchange, but oblige acceptance of smaller, less frequent orders and limited data access.

Transactions occur on a peer-to-peer basis and are captured in near-real time in the blockchain 520, which effectively serves as a master blotter. At the end of the trading session, the exchange back-office nets out the blockchain 520 and each trader receives an individual blotter and net positions for settlement. Some enterprises transact on an omnibus basis for multiple clients' sub-accounts and accept the responsibility for further subdivision of that activity into those sub-accounts.

Examples of multi-blockchain implementations will now be described. The prescription and provision of diagnostic medical tests, the management of the supply chain for the home and in-office samples, the arrangements for approval and payment and the dissemination the results is an exceptionally complicated process. Patient privacy and epidemiological concerns are often in conflict.

The FDA, a US federal agency, is empowered to enforce the Federal Food, Drug, and Cosmetic Act, and regulates at-home tests as medical devices. Clinical Laboratory Improvement Amendments (CLIA) of 1988 are United States federal regulatory standards that apply to clinical laboratory testing performed on humans. Centers for Medicare and Medicaid Services (CMS) has the primary responsibility for the operation of the CLIA Program.

The Centers for Disease Control and Prevention (CDC), a federal agency under the Department of Health and Human Services is charged with monitoring reportable or notifiable diseases. The National Notifiable Diseases Surveillance System (NNDSS) is a nationwide collaboration that enables all levels of public health—local, state, territorial, federal, and international—to share notifiable disease-related health information. As part of the CDC Surveillance Strategy, the NNDSS Modernization Initiative (NMI) is underway to enhance the system's ability to provide more comprehensive, timely, and higher quality data than ever before for public health decision making.

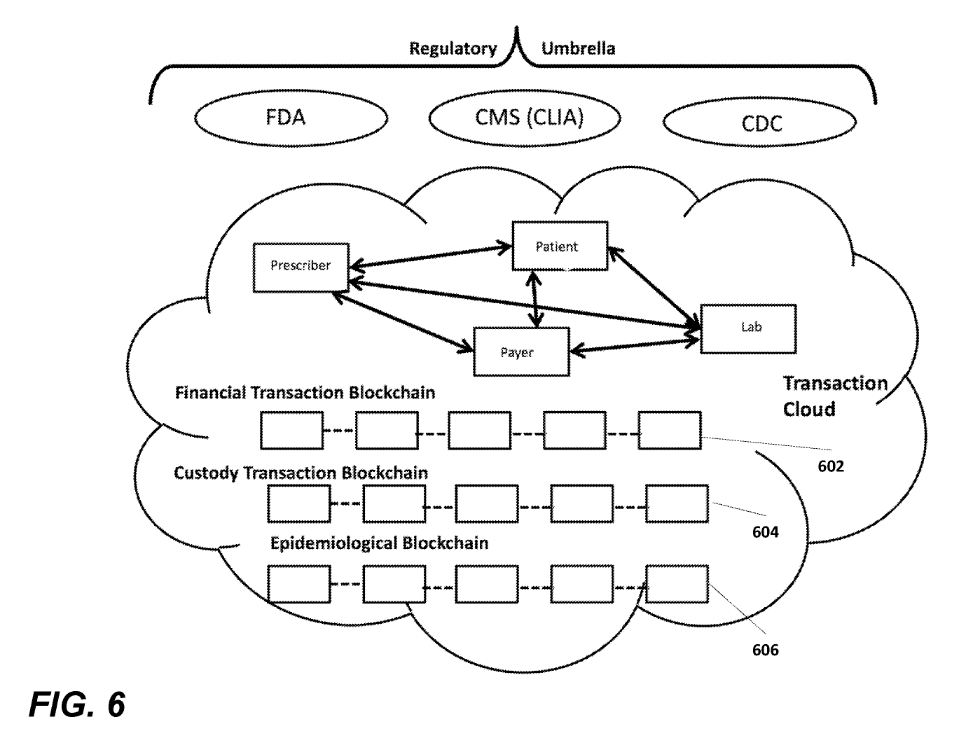

The present blockchain-based system is designed to meet the needs of all participants and regulators. In this implementation, depicted in FIG. 6, the system has as its backbone a set of triple permissioned blockchains 602, 604, and 606, together embodying a single version of the truth. One blockchain 604 encodes the chain of custody for the serialized sample, another blockchain 606 encodes the results for reporting to the CDC for epidemiological study, while the third blockchain 602 encodes the associated financial transactions. These blockchains 602, 604, and 606 can be further subdivided into more instantiations to enhance privacy, scalability or other metrics. The blockchains 602, 604, and 606 can be configured to support relevant standards, such as HL7.

In this manner, the regulators and clinical labs have a complete, near real-time view of the supply chain in its entirety. Detailed analyses of the blockchains may otherwise be limited to permissioned entities and other “covered entities” as defined by HIPAA, for example health insurance companies, payers and academic centers. Viewers can be permissioned to analyze appropriately anonymized copies of the blockchains 602, 604, and 606; in this manner, certain data is protected, for example, trading partner aggregate activity might remain confidential. The regulators may determine that several instantiations of the blockchains 602, 604, and 606 are desired.

In another example, special multi-tenancy wallets are contemplated for institutional settings such as hospitals and nursing homes, to allow the blockchain-based system to serve the market for automated dispensing cabinets, such as those from Pyxis and Omnicell. In this implementation, the cabinet can host both the dispensing wallet and end-user wallets, while the end-user is outfitted with a passive device, so that the practitioner can manage the complete interaction. The passive device will interact with the dispensing cabinet to assure the recipient is the correct patient, thereby reducing errors.

Example implementations of the system as used for supply chain tracking will now be described. As noted above, the agency is empowered to enforce the Federal Food, Drug, and Cosmetic Act. The FDA also enforces other laws, including Section 361 of the Public Health Service Act and associated regulations, which increase its scope of authority well beyond food, drugs and cosmetics, to include tobacco products, dietary supplements, vaccines, blood transfusions, medical devices, electromagnetic radiation emitting devices (ERED), animal food & feed and veterinary products.

Recent Acts of Congress have mandated enhanced oversight by the FDA: the Tobacco Control Act (2009); the Food Safety Modernization Act (2011); the Food and Drug Administration Amendments Act of 2007 (FDAAA) which further secures the drug supply chain against counterfeit, diverted, subpotent, substandard, adulterated, misbranded, and expired drugs; and the Food and Drug Administration Safety and Innovation Act (2012) extending this supply chain mandate globally.

In particular, the Drug Quality and Security Act (2013) requires an electronic system to identify and trace drugs, with a 24 hour notification and response deadline, effectively mandating a near-real time system of record at the package and transaction level. The foundational piece of the chain of custody requirement is serialization, which is the assignment of a unique traceable number at the salable package level. This new electronic system requires complete transaction information: drug name, strength and dosage form, National Drug Code number, container size, number of containers, lot number, date of transaction, date of shipment, business name and address of person from whom ownership is being transferred and business name and address of person whom ownership is being transferred to, in a chain from the manufacturer through to the dispenser, at a minimum. Rapid and accurate exchange of this information around the transaction is required, as ownership of a drug may not be transferred until required transaction information, history and statement is provided by the current owner to the prospective owner. The transaction data may map onto known standards such as EPCIS.

The DEA, a federal law enforcement agency under the Department of Justice, is the lead agency for domestic enforcement of the Controlled Substances Act. Prescribers and trading partners are assigned a DEA number. Trading partners must file DEA Form 222, which has traditionally been a paper form whose filing incurs a sixty day lag. DEA's Interim Final Rule with Request for Comment titled “Electronic Prescriptions for Controlled Substances” [Docket No. DEA-218, RIN 1117-AA61] became effective Jun. 1, 2010. The rule provides practitioners with the option of writing prescriptions for controlled substances electronically. The regulations also permit pharmacies to receive, dispense, and archive these electronic prescriptions. The regulations provide pharmacies, hospitals, and practitioners with the ability to use modern technology for controlled substance prescriptions while maintaining the closed system of controls on controlled substances.

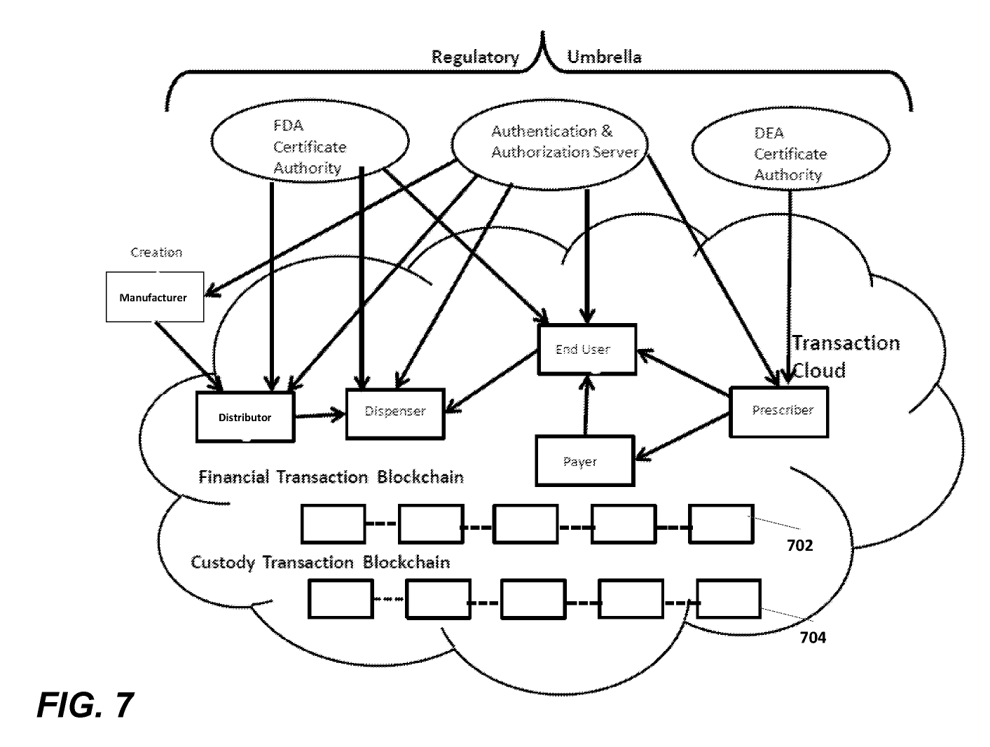

The present, real-time blockchain-based system is designed to meet the requirements of both regulators. Referring to FIG. 7, the system has as its backbone one or more permissioned blockchains, with a single version of the truth. In the depicted implementation, the system includes two blockchains 702 and 704: a blockchain 702 to track financial aspects of a transaction and a blockchain 704 to track custodial aspects of the transaction. However, any number of blockchains can be used.

Manufacturers are permissioned by the FDA, as certifying authority, to add newly manufactured product to a system with a special genesis wallet. Each trading partner (manufacturer, distributor, dispenser) is permissioned by the certifying authority and in turn arranges the certification for every authorized user, who are issued wallets in which their identity can be anonymous but is verifiable. These wallets generate transactions for permanent inclusion into the blockchain, and de-duplication is automated: there is no opportunity for either an authorized or non-authorized user to add a duplicate serial number into the blockchain. Embedded in the transaction is required transaction information including drug name, lot number, ownership, date of transaction, transaction history, and transaction statement which documents the transfer of ownership of a drug from one entity to another along the supply chain. The system automatically generates notification of product suspected to be counterfeit, stolen, contaminated, or otherwise harmful to the relevant regulator while delaying or blocking the addition of that transaction to the blockchain. Those transactions can be marked as quarantined to fulfill that requirement of the Act.

In this manner, the FDA and the DEA have a complete, near real-time view of the supply chain in its entirety, as if the entire supply chain was inside a single warehouse. Detailed analyses of the blockchains may otherwise be limited to permissioned entities and other “covered entities” as defined by HIPAA, for example health insurance companies, payers and academic centers. Viewers may be permissioned to analyze appropriately anonymized copies of the blockchains; in this manner, certain data is protected, for example, trading partner aggregate activity might remain confidential. The FDA may determine that several instantiations of the blockchain are desired to meet the mandates of the Act; for example, controlled substances may reside on one blockchain instantiation while other products may reside on another.

The system can include additional relevant transaction data such as lot expiration date. Time-out scripts may be used to render expired product unsalable. The system can be linked to other databases or billing engines to provide proof of custody change, to generate invoices, shipment notices and purchase orders. Any data deemed sensitive can be further encrypted, compartmentalized or stored separately from the system, so as to protect competitive data and avoid running afoul of antitrust laws.

In this manner, certain private business data and personal information may not be available for viewing by either permissioned or un-permissioned parties, but the supply chain is fully updated in near real-time, meeting the objectives of DQSA.

A full implementation of the system further includes a special end consumer wallet. This user wallet can have reduced privileges compared to trading partners. For example, as with end user wallets in general, such user wallets can validate owned items, but cannot create change of owner blocks for insertion into a blockchain. For the present implementation, other examples limitations include the end user wallet having a multi-signature structure or a smart contract requiring the interaction of either the prescriber or the payer, or both, in addition to the end user. The end user wallet can enable the complete elimination of the prescription system itself in favor of this more robust and secure blockchain-based method. In addition, unused retail product is less likely to contaminate the supply chain through gray market activity or supply chain reflux. Further still, upon dispensing medications or other consumable products to an end user, the unique identifier (e.g., barcode) associated with the product can be expired or otherwise retired such that the product associated with the unique identifier is blocked from being reused by the manufacturer or entering the supply chain system in another way (e.g., a transaction involving the unique identifier would not be able to be validated or notarized).

In another example implementation, the blockchain system tracks the movement of explosives, firearms, and similar items. The Bureau of Alcohol, Tobacco, Firearms and Explosives (ATF) is a US federal law enforcement organization. Its responsibilities include the investigation and prevention of federal offenses involving the unlawful use, manufacture, and possession of firearms and explosives; acts of arson and bombings; and illegal trafficking of alcohol and tobacco products. The ATF also regulates via licensing the sale, possession, and transportation of firearms, ammunition, and explosives in interstate commerce. With the passage of the Organized Crime Control Act (OCCA) in 1970, ATF took over the regulation of explosives in the United States, as well as prosecution of persons engaged in criminal acts involving explosives. ATF also enforces provisions of the Safe Explosives Act, passed after 9/11 to restrict the use/possession of explosives without a federal license to use them.

The Pipeline and Hazardous Materials Safety Administration (PHMSA), within the U.S. Department of Transportation (DOT), has regulatory and civil enforcement authority over the transportation of explosive materials in commerce. The regulatory enforcement of explosive materials while they are not being transported falls under ATF jurisdiction. In effect, explosives are constantly changing venue and regulator, reliant upon the goodwill of all to file paperwork in a timely fashion, a period which often extends three to six months.

The present implementation maintains a near real-time archive of all movements of high explosives and ancillary products (for example, blasting caps), assigning each movement to the holder of a license who in turn has a blockchain wallet. This system is a closed system with permissions granted to government, military and first responders and licensed IME members. Validation is under the aegis of the ATF, who can retain outside contractors competing to update the blocks. Regulators at the ATF and the PHMSA can track all shipments in near real-time on a consolidated basis.

In general, implementations of the blockchain-based system described herein can use appropriate hardware or software; for example, components of the system can run an operating system such as the Microsoft Windows® operating systems, the Apple OS X® operating systems, the Linux® operating system and other variants of UNIX® operating systems. For mobile devices, such operating systems can include the Apple iOS® platform or the Google Android™ platform. The hardware can be in the form of a computer including a processing unit, a system memory, and a system bus that couples various system components including the system memory to the processing unit.

Some or all of the functionality described herein can be performed remotely, in the cloud, or via software-as-a-service. Such remote functionality can execute on server class computers that have sufficient memory, data storage, and processing power and that run a server class operating system (e.g., Oracle® Solaris®, GNU/Linux®, and the Microsoft® Windows® family of operating systems).

The system can include a plurality of software processing modules stored in a memory and executed on a processor. By way of illustration, the program modules can be in the form of one or more suitable programming languages, which are converted to machine language or object code to allow the processor or processors to execute the instructions. The software can be in the form of a standalone application implemented in a suitable programming language or framework.

Method steps of the techniques described herein can be performed by one or more programmable processors executing one or more computer programs to perform functions by operating on input data and generating output. Method steps can also be performed by, and systems can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors. Generally, a processor receives instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store assets (e.g., documents, audio, video, graphics, interface elements, and/or other files), configuration files, and/or instructions that, when executed by a processor, form the modules, engines, and other components described herein and perform the functionality associated with the components. The processor and the memory can be supplemented by, or incorporated in, special purpose logic circuitry.

The system can also be practiced in distributed computing environments, where tasks are performed by remote processing devices that are linked through a communications network. In a distributed computing environment, program modules can be located in both local and remote computer storage media including memory storage devices. Other types of system hardware and software than that described herein can also be used, depending on the capacity of the device and the amount of required data processing capability. The system can also be implemented on one or more virtual machines executing virtualized operating systems, such as those mentioned above, and that operate on one or more computers having hardware, such as that described herein.

It should also be noted that implementations of the systems and methods can be provided as one or more computer-readable programs embodied on or in one or more articles of manufacture. The program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The terms and expressions employed herein are used as terms and expressions of description and not of limitation, and there is no intention, in the use of such terms and expressions, of excluding any equivalents of the features shown and described or portions thereof. In addition, having described certain implementations in the present disclosure, it will be apparent to those of ordinary skill in the art that other implementations incorporating the concepts disclosed herein can be used without departing from the spirit and scope of the invention.

The features and functions of the various implementations can be arranged in various combinations and permutations, and all are considered to be within the scope of the disclosed invention. Accordingly, the described implementations are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

1. A computer-implemented method for managing transactional data in cryptographically-signed blocks in a blockchain-based system, the method comprising:
identifying a plurality of digital wallets each comprising a private cryptographic key for digitally signing data recorded in a blockchain, wherein each digital wallet is respectively associated with at least one privilege defining a permitted or restricted operation of the digital wallet within the blockchain-based system, and wherein each digital wallet is respectively associated with a party attempting to perform a transaction;
receiving, from at least one of the parties performing the transaction, (i) unencrypted data for validating the transaction and (ii) a reference to an existing block in the blockchain, the existing block comprising a hash, a public key, and encrypted data;
validating the unencrypted transaction data by verifying the hash on the existing block and determining whether applying the public key to the unencrypted data yields the encrypted data in the existing block; and
verifying whether the transaction can be performed based on the privileges associated with the digital wallets of the parties attempting to perform the transaction.

2. The method of claim 1, wherein the digital wallets are respectively associated with parties associated with the manufacturing, distributing, dispensing, and/or consumption of a discrete product, and wherein each transaction in the blockchain defines a transfer of the discrete product from one of the parties to another one of the parties.

3. The method of claim 2, wherein a particular transfer of the discrete product from a transferring party to a receiving party results in a creation of a notarized block for validation of the discrete product by the receiving party.

4. The method of claim 3, wherein the notarized block can be verified without decrypting contents of the notarized block.

5. The method of claim 2, wherein a digital wallet associated with a manufacturer has associated a privilege defining that the manufacturer is permitted to generate an initial transaction in the blockchain, the generating including introducing a unique random identifier associated with the discrete product.

6. The method of claim 5, wherein a physical representation of the unique random identifier is disposed on at least one of the discrete product and packaging of the discrete product.

7. The method of claim 1, wherein the at least one privilege comprises a security requirement for generating a transaction using a digital wallet, the security requirement comprising at least one of multi-factor authentication, a cryptographic key, a challenge question, a digital signature, and a smart contract.

8. The method of claim 7, wherein elements of the smart contract comprise at least one of transparent elements, elements encoded in a script, and remotely stored elements.

9. The method of claim 1, wherein the at least one privilege is defined based on (i) a size or type of transaction to be generated using a digital wallet, (ii) a balance associated with a digital wallet, or (iii) an age of a digital wallet.

10. The method of claim 1, wherein the at least one privilege is defined based on whether an owner of a digital wallet is within a geographical area defined by a geo-fence.

11. The method of claim 1, wherein the at least one privilege permits or restricts resale of a discrete product, a short sale, a purchase or sale of a discrete product having a value that exceeds a threshold, purchase of a discrete product on credit, or generation of a transaction outside of a particular time period.

12. The method of claim 1, wherein the at least one privilege is associated with a particular user role in a hierarchy of user roles, wherein each user role in the hierarchy defines a set of privileges to associate with a digital wallet to which the user role is assigned.

13. A system for managing transactional data in cryptographically-signed blocks in a blockchain-based system, the system comprising at least one non-transitory computer-readable medium having computer-executable instructions stored thereon, and at least one processor for executing the instructions, wherein the instructions include operations comprising:
identifying a plurality of digital wallets each comprising a private cryptographic key for digitally signing data recorded in a blockchain, wherein each digital wallet is respectively associated with at least one privilege defining a permitted or restricted operation of the first digital wallet within the blockchain-based system, and wherein each digital wallet is respectively associated with a party attempting to perform a transaction;
receiving, from at least one of the parties performing the transaction, (i) unencrypted data for validating the transaction and (ii) a reference to an existing block in the blockchain, the existing block comprising a hash, a public key, and encrypted data;
validating the unencrypted transaction data by verifying the hash on the existing block and determining whether applying the public key to the unencrypted data yields the encrypted data in the existing block; and
verifying whether the transaction can be performed based on the privileges associated with the digital wallets of the parties attempting to perform the transaction.

14. The system of claim 13, wherein the digital wallets are respectively associated with parties associated with the manufacturing, distributing, dispensing, and/or consumption of a discrete product, and wherein each transaction in the blockchain defines a transfer of the discrete product from one of the parties to another one of the parties.

15. The system of claim 14, wherein the operations further comprise, on a particular transfer of the discrete product from a transferring party to a receiving party, creating a notarized block for validation of the discrete product by the receiving party.

16. The system of claim 15, wherein the operations further comprise verifying the notarized block without decrypting contents of the notarized block.

17. The system of claim 14, wherein a digital wallet associated with a manufacturer has associated a privilege defining that the manufacturer is permitted to generate an initial transaction in the blockchain, the generating including introducing a unique random identifier associated with the discrete product.

18. (canceled)

19. The system of claim 1, wherein the at least one privilege comprises a security requirement for generating a transaction using a digital wallet, the security requirement comprising at least one of multi-factor authentication, a cryptographic key, a challenge question, a digital signature, and a smart contract.

20. The system of claim 19, wherein elements of the smart contract comprise at least one of transparent elements, elements encoded in a script, and remotely stored elements.

21. The system of claim 13, wherein the at least one privilege is defined based on (i) a size or type of transaction to be generated using a digital wallet, (ii) a balance associated with a digital wallet, or (iii) an age of a digital wallet.

22. The system of claim 13, wherein the at least one privilege defines a permitted or restricted operation of a digital wallet given a location of an owner of the digital wallet with respect to a geographical area defined by a geo-fence.

23. The system of claim 13, wherein the at least one privilege permits or restricts resale of a discrete product, a short sale, a purchase or sale of a discrete product having a value that exceeds a threshold, purchase of a discrete product on credit, or generation of a transaction outside of a particular time period.

24. The system of claim 13, wherein the at least one privilege is associated with a particular user role in a hierarchy of user roles, wherein each user role in the hierarchy defines a set of privileges to associate with a digital wallet to which the user role is assigned.
